(19) United States
(12) Patent Application Publication
(10) Pub. No.: US 2002/0065098 A1
(43) Pub. Date: May 30, 2002

(54) Portable information-processing apparatus and method for controlling wireless communication device provided in the apparatus

(75) Inventor: Reina Hosogaya, Hamura-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 09/949,752

(22) Filed: Sep. 12, 2001

(30) Foreign Application Priority Data
Nov. 30, 2000 (JP) 2000-365250

(51) Int. Cl. H04M 1/00

(52) U.S. Cl. 455/552; 455/550; 455/553

(57) ABSTRACT

A portable information-processing apparatus includes first and second wireless communication devices. The apparatus further includes a wireless communication control switch and a controller configured to disable the wireless communication devices, when the wireless communication control switch is operated in a state where the portable information-processing apparatus is powered on.

### CROSS-REFERENCE TO RELATED APPLICATIONS

This application is based upon and claims the benefit of priority from the prior Japanese Patent Application No. 2000-365250, filed Nov. 30, 2000, the entire contents of which are incorporated herein by reference.

### BACKGROUND OF THE INVENTION

1. Field of the Invention

The present invention relates to a portable information-processing apparatus such as a personal computer and to a method for controlling wireless communication devices provided in the apparatus.

2. Description of the Related Art

In resent years, various portable computers, such as notebook-type personal computers, laptop personal computers and the like, have been developed and marketed. A portable computer is small and light, designed for outdoor use. Driven by the build-in battery, the portable computer can be used in any place.

If communicated with other computers in an office or a house, however, the portable computer must be connected a LAN cable or the like. That is, places where it can be used are limited.

Recently it has been proposed that portable computers should incorporate a wireless communication device that accords with short-range wireless communication standards, such as IEEE802.11, Bluetooth (TM) or the like. Equipped with such a wireless communication device, a portable computer can perform data communication, by radio wave, with other various electronic apparatuses. Since radio waves may affect measuring instruments and people, the wireless communication device provided in the portable computer should not be used in airplanes or hospitals. Especially, wireless communication devices of short-range wireless communication standards such as IEEE802.11 and Bluetooth (TM), transmit and receive radio waves of 2.4 GHz, called “ISM (Industrial Scientific and Medical) band waves.” These wireless communication devices may more affect measuring instruments and other electronic devices than cellular telephones do.

The U.S. patent application Ser. No. 09/612,275 filed by the applicant hereof discloses an electronic device that controls electromagnetic radiation. When the device is brought into any electromagnetic radiation control area, it automatically starts controlling electromagnetic radiation from it.

Such an auto-control function may be extremely effective if applied to a portable computer. However, the manufacturing cost of a portable computer with the auto-control function is high. It is desired that a portable computer that can control electromagnetic radiation be provided, without an increase in the manufacturing cost.

### BRIEF SUMMARY OF THE INVENTION

An object of the present invention is to provide a portable information-processing apparatus that has a simple structure and can yet reliably control electromagnetic radiation.

According to an aspect of the invention, there is provided a portable information-processing apparatus powered on according to operation of a power switch. The apparatus comprises: a main body; a first wireless communication device provided in the main body, configured to execute a wireless data communication according to a first communication protocol, by using radio wave; a second wireless communication device provided in the main body, configured to execute a wireless data communication according to a second communication protocol, by using radio wave; a wireless communication control switch provided on the main body; and a controller provided in the main body, and connected to the wireless communication control switch, configured to disable the first and second wireless communication devices, when the wireless communication control switch is operated in a state where the portable information-processing apparatus is powered on.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a portable information-processing apparatus according to one embodiment of the invention, with its display opened;

FIG. 2 is a front view of the apparatus, with its display closed;

FIG. 3 is a block diagram of the portable information-processing apparatus;

FIG. 4 illustrates the principle of the ON/OFF control operation on the wireless communication device provided in the portable information-processing apparatus;

FIG. 5 shows a relationship between the respective ON/OFF operation of the power switch and the wireless communication control switch, both provided in the portable information-processing apparatus, and also showing the ON/OFF state of the wireless communication device;

FIG. 6 shows the hardware for the ON/OFF control of the wireless communication device provided in the portable information-processing apparatus;

FIG. 7 is a flowchart showing the sequence of processes to be performed when the wireless communication control switch changes from the ON state to the OFF state; and

FIG. 8 is a flowchart showing the sequence of processes to be performed when the wireless communication control switch changes from the OFF state to the ON state.

### DETAILED DESCRIPTION OF THE INVENTION

An embodiment of the present invention will be described with reference to the accompanying drawings.

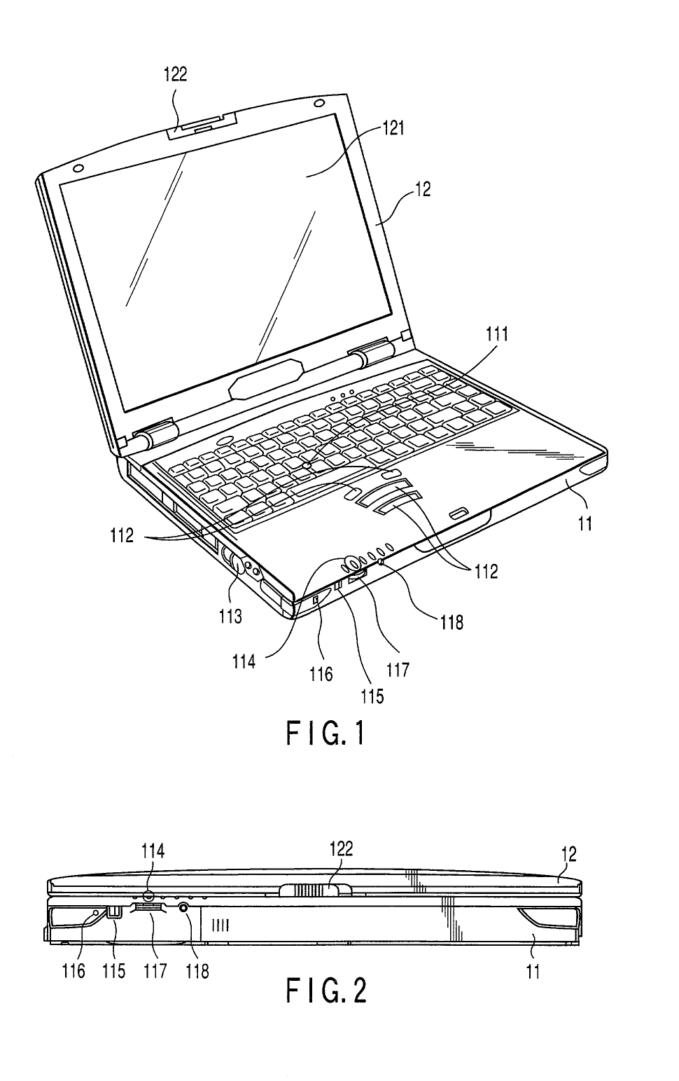

First, a portable information-processing apparatus according to the embodiment of the invention will be described, with reference to FIGS. 1 and 2. The apparatus is a portable computer, for example, a notebook-type personal computer. FIG. 1 is a perspective view of the portable computer with its display opened. FIG. 2 is a front view of the portable computer with its display closed.

The portable computer comprises a body 11 and a display unit 12. The display unit 12 incorporates a display screen 121, or an LCD, approximately in the middle part. This display unit 12 can be rotated between an opened position and a closed position. At the closed position, the display unit 12 is attached to the computer body 12 by a display latch 122 provided on the display unit 12.

The computer body 12 is a thin box-shaped case. A keyboard, a pointing device 111, and a pointing control button 112 are arranged on the top of the body 12. A LED 114 configured to display the power-supply status (power ON/power OFF) of the computer is mounted on the top of the computer body 11.

A power switch 113 is used to power on and power off the computer, and is provided on the left side of the computer body 11. On the front of the computer body 11 there are provided a wireless communication control switch 115, a wireless communication status LED 116, a volume dial 117, a reset switch 118 and the like. The wireless communication control switch 115 is used to turn on and off the wireless communication devices that are incorporated into the computer body 11. The wireless communication status LED 116 displays the ON/OFF state of the wireless communication devices. The volume dial 117 is provided for sound volume adjustment.

The wireless communication control switch 115 is an operation switch dedicated to the wireless communication device and provided for ON/OFF control of the wireless communication devices keeping the computer in the powered ON state. The user can switch the power state of the wireless communication devices, from the ON state (enable state) to OFF state (disable state), and vice versa, while the computer stays in the ON state, by operating the wireless communication control switch 115. The wireless communication LED 116 is controlled in accordance to the switching ON/OFF of the wireless communication devices. More precisely, the LED 116 is on while the wireless communication device remains ON, and is off while the wireless communication device remains OFF.

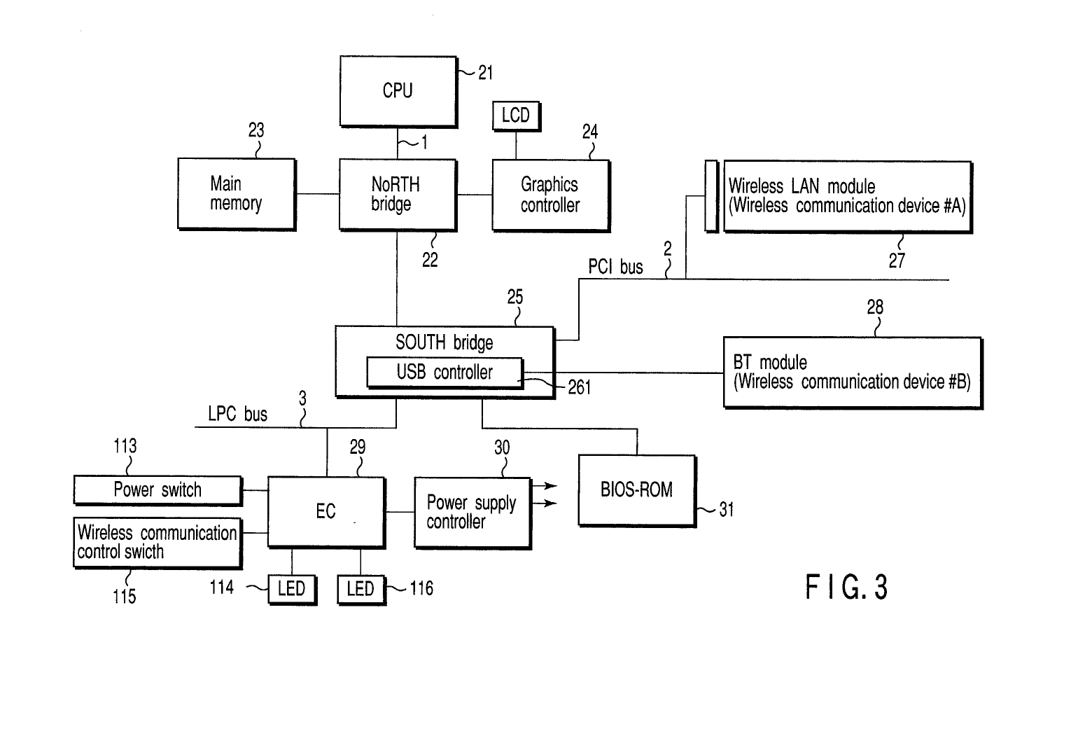

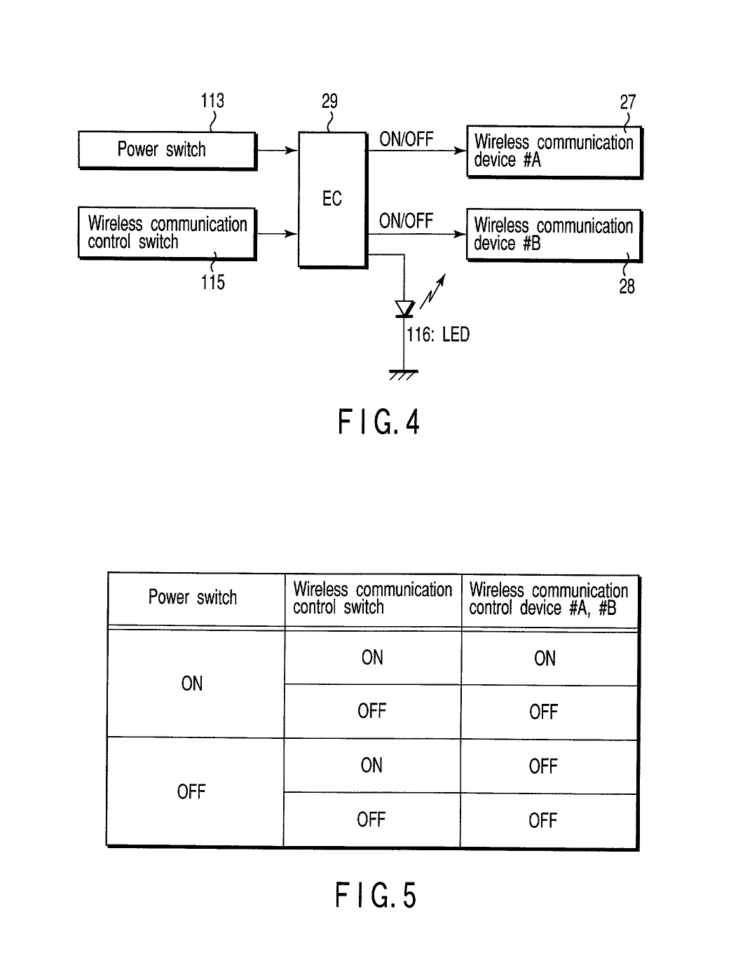

FIG. 3 is a block diagram showing the computer system.

As illustrated, the system comprises a CPU 21, a NORTH bridge 22, a main memory 23, a graphics controller 24, a SOUTH bridge 25, a wireless LAN module 27, Bluetooth (TM) module 28 (hereafter called BT module 28), an EC (Embedded Controller) 29, a power supply controller 30, and a BIOS-ROM 31.

The CPU 21 controls the other components of the system. It executes operating system, application programs and BIOS, both stored in the main memory 23. The NORTH bridge 22 is connected to a CPU bus 1. The NORTH bridge 22 controls the main memory 23, and can transmit and receive data to and from the graphics controller 24 through a video bus such as AGP.

The SOUTH bridge 25 controls the devices provided on a PCI bus 2, the devices provided on a LPC (Low Pin Count) bus 3, and the other devices. The SOUTH bridge 25 incorporates an USB controller 261, which controls the USB device.

The wireless LAN module 27 is designed to achieve wireless data communication with other wireless communication apparatuses, by using radio waves of ISM band. The wireless LAN module 27 uses the short-range wireless data communication protocol based on the IEEE802.11b standard that utilizes the spread spectrum communication method. The wireless LAN module 27 is used to connect the portable computer to one or more other wireless communication apparatus(es), of IEEE802.11b standard.

The wireless LAN module 27 is comprised of a Mini PCI card. The Mini PCI card is a miniature PCI card designed for the note type personal computer. It can be used after inserted into the Mini PCI card slot that is provided in the back of the computer body 11. Once after inserted into the Mini PCI card slot, the wireless LAN module 27 remains connected directly to the PCI bus 2 and functions as a PCI device.

The BT module 28 is a wireless communication device that can perform the wireless data communication with other wireless communication apparatuses, by using radio waves of ISM band. The BT module 28 uses the short-range wireless radio data communication protocol prescribed by the Bluetooth (TM) standard. In the Bluetooth (TM) standard, the spread spectrum communication method employing frequency hopping is used. The Bluetooth (TM) standard is used for wireless communication between various electronic devices. The BT module 28 is mounted on the system board, likewise the other components of the portable computer. It is connected to the USB controller 261 as illustrated.

The EC (Embedded Controller) 29 performs a power management of the system, in corporation with the power supply controller 30. The power Supply controller 30 begins to supply respective component in the system with power to power ON the system, in response to the signal indicating the ON operation of the power switch 113 from the EC 29 and stops supplying respective component in the system with power to power OFF the system, in response to the signal indicating the OFF operation of the power switch 113 from the EC 29. The EC 29 keep monitoring the power switch 113 and the wireless communication control switch 115 all the times. The EC 29 performs the control to disable the wireless LAN module 27 and the BT module 28, when the wireless communication control switch 115 is switched OFF, and performs the control to enable the wireless LAN module 27 and the BT module 28, when the wireless communication control switch 115 is switched ON. Further, the EC 29 perform a control, turning on and off the LEDs 114 and 116, thereby showing the power states of the system and the operation states of the wireless LAN module 27 and BT module 28 to the user.

The BIOS-ROM 31 contains a BIOS (Basic Input Output System) that is a program systemizing routine for controlling respective hardware in the system.

The principle of ON/OFF control of the wireless communication function in the system will be described.

As mentioned above, the wireless communication control switch 115 and the EC 29 execute the ON/OFF control of the wireless communication function. When the user turns off the switch 115 while the power switch 113 remains on, or the system is powered on, the EC 29 outputs a disable signal to the wireless LAN module (wireless communication device #A) 27 and the BT module (wireless communication device #B) 28, thus stopping the operations of the modules 27 and 28. Only the wireless LAN module 27 and the BT module 28 stop operating, though the system remains on. Almost all components other than the modules 27 and 28 are in operation. Further, the EC 29 turns off the LED 116, informing the user that the wireless communication function of the system is disabled.

When the user switches the wireless communication control switch 115 from OFF state to ON state while the system remains on, the EC 29 detects this and output, an enable signal to the wireless LAN module 27 and the BT module 28, activating them. The modules 27 and 28 are enabled. The EC 29 turns on the LED 116, informing the user that the wireless communication function of the system has been activated.

FIG. 5 shows the relationship between respective ON/OFF state of the power switch 113 and the wireless communication control switch 115 and ON/OFF state of respective wireless communication device #A, B.

While the power switch 113 remains on, or the system is powered on, the wireless communication devices #A and #B are enabled as the wireless communication control switch 115 is turned on, and are disabled as the switch 115 is turned off. While the power switch 113 remains off, or the system is powered off, no power is supplied to the components including the wireless communication devices #A and #B. In this case, the wireless communication devices #A and #B are off or disabled, irrespective of the ON/OFF operation of the wireless communication control switch 115.

The wireless communication control switch 115 is a two-position switch that can have two states. It is a slide switch, for instance, and stays in one state until it is operated to assume the other state. When the power switch 113 is turned on while the wireless communication control switch 115 remains on, the power supply controller 30 supplies power to all components, including wireless communication devices #A and #B. The system is thereby powered on. When the power switch 113 is turned ON while the wireless communication control switch 115 remains off, the system is powered on, but the wireless communication devices #A and #B remain off.

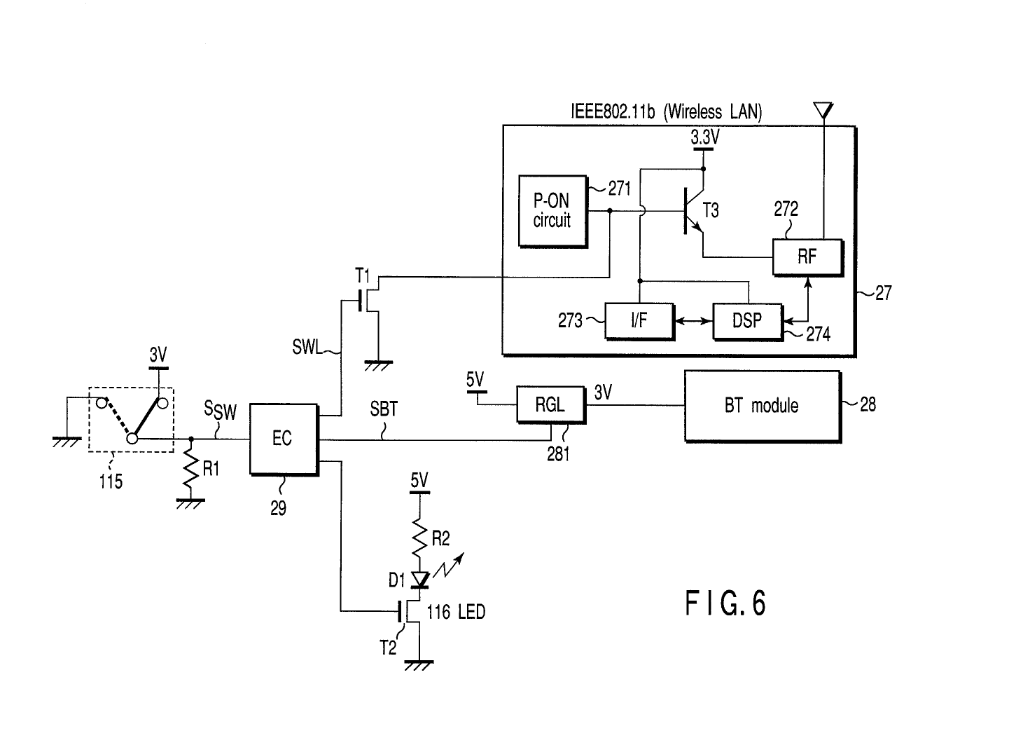

The hardware configuration concerning the ON/OFF control of the wireless communication function will be described, with reference to FIG. 6.

As FIG. 6 shows, the wireless communication control switch 115 is connected to the EC 29 by a switch status signal S_{sw} line. When the wireless communication control switch 115 is changed over to ON state, or connected to 3V power source terminal as illustrated by the solid line, the switch status signal S_{sw} rises from “L” level to “H” level. When the wireless communication control switch 115 is changed over to OFF state, or connected to the earth terminal as indicated by the broken line, the switch status signal S_{sw} falls from “H” level to “L” level. The EC 29 determines whether the wireless communication control switch 115 is on or off, in accordance with the logic level of the switch status signal S_{sw}.

The ON/OFF control of the operation of the wireless LAN module 27 is performed in accordance with the switch status signal SWL line output from the EC 29. When the user turns off the wireless communication control switch 115, that is, when the switch status signal S_{sw} falls from “H” to “L” level, the EC 29 sets the wireless LAN control signal SWL to “H” level. This turns on a transistor T1 thereby shutting off the supply of power to an RF transceiver 272 provided in the wireless LAN module 27.

Usually, a power supply ON circuit 271 provided in the radio LAN module 27 turns on a transistor T3 all the times. When the wireless communication control switch 115 is turned off, the transistor T3 is turned off because the base current of the transistor T3 is extracted to the earth terminal by the transistor T1 turned on. The supply of power to the RF transceiver 272 is stopped. As a result, the RF transceiver 272 neither transmits nor receives radio wave. The wireless LAN module 27 can be set to the off state and radio wave can no longer be emitted. Therefore, electromagnetic radiation from the wireless LAN module 27 is none.

In this case, only the power supply to the RF transceiver 272 is turned off. Power is continuously supplied from the power supply controller 30 to a bus interface unit 273 and a DSP (Digital signal Processor) 274, which are other components of the wireless LAN module 27. The bus interface unit 273 acts as an interface with the PCI bus 2. The DSP 274 modulates the data to be transmitted from the RF transceiver 272 and also data received the RF transceiver 272 has received.

The power supply only to the RF transceiver 272 is turned OFF in this way, because the wireless LAN module 27 is a PCI device connected directly to the PCI bus 2 as mentioned above. If the supply of power to the bus interface unit 273 provided in the wireless LAN module 27 is stopped abruptly, there is every possibility that an erroneous operation be provoked to the other devices on the PCI bus 2.

When the wireless communication control switch 115 is changed over to ON state by the user, namely when the switch status signal S_{sw} rises from “L” level to “H” level, the EC 29 sets the wireless LAN control signal SWL to “L” level. The transistor T1 is thereby turned off. The power supply ON circuit 271 turns on the transistor T3, whereby power is supplied to the RF transceiver 272.

The OF/OFF control of the BT module 28 is performed in accordance with the BT control signal SBT output from the EC 29. When the user turns off the wireless communication control switch 115, that is, when the switch status signal S_{sw} falls from “H” level to “L” level, the EC 29 sets the BT control signal SBT to “H” level. A voltage regulator (RGL) 281 configured to generate power for the BT module 28 from the power supplied from the power supply controller 30 is turned OFF. The supply of power to the BT module 28 is stopped. In this case, a sufficient power saving effect can be obtained as all components in the BT module 28 are turned off. As a result, the BT module 28 neither transmits nor receives radio wave. Therefore, electromagnetic radiation from the BT module 28 is none.

The LED 116 comprises a resistor R2, a light emitting diode D1 and a transistor T2. The LED 116 is turned on or off as the logical level of switch status signal S_{sw} changes under the control of the EC 29.

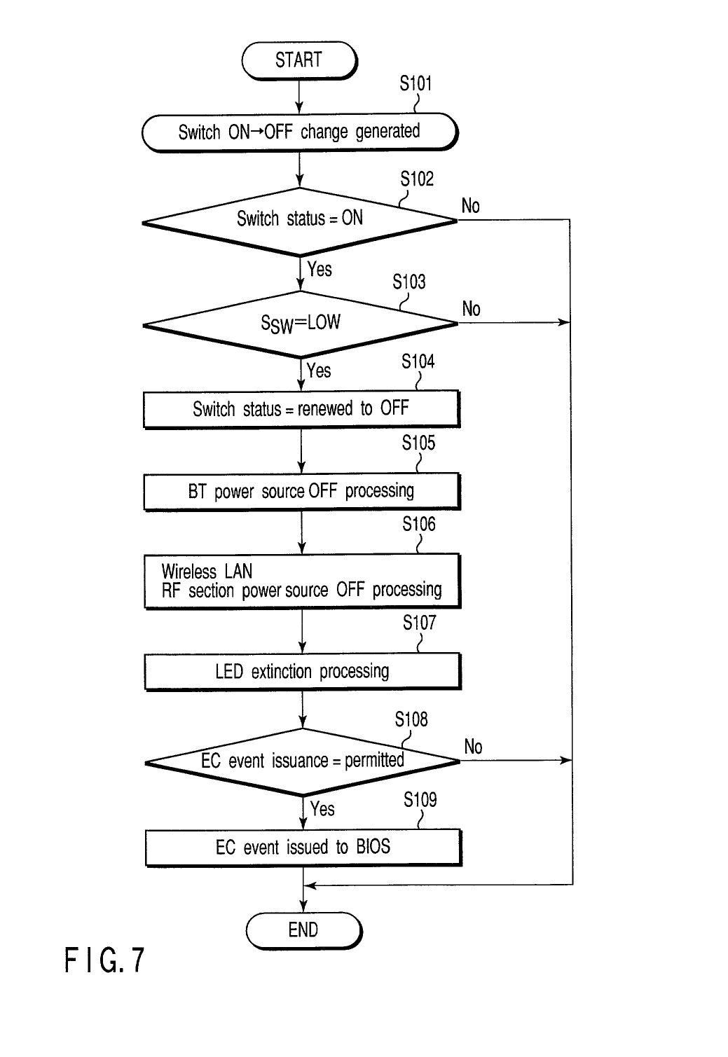

How the EC 29 operates when the wireless communication control switch 115 is turned off while the system remains on will be explained, with the flowchart of FIG. 7.

The EC 29 detects the ON operation and OFF operation of the wireless communication control switch 115, from the status management flag that indicates whether the wireless communication control switch 115 assumes ON state or OFF state, and from the logical level of switch status signal S_{sw}. The status management flag is an internal flag to be set in a register provided in the EC 29.

When the wireless communication control switch 115 is turned off (step S101), the EC 29 detects that the wireless communication control switch 115 has changed from ON state to OFF state, provided that the status management flag is ON (indicating that the wireless communication control switch 115 has been in ON state) (YES in step S102), and the actual switch status signal S_{sw} is LOW (YES in step S103). Next, the EC 29 changes the status of the status management flag from ON to OFF (step S104).

Next, the EC 29 sets BT control signal SBT to “H” level, turning off the power source of the BT module 28 (step S105). At the same time, the EC 29 sets the wireless LAN control signal SWL to “H” level, turning off the power source of the RF transceiver 272 (step S106). Then, the EC 29 turns off the LED 116, informing the user that all wireless communication functions are disabled (step S107). Thereafter, the EC 29 determines whether the issuance of power management event (EC event) to the BIOS is permitted or not (step S108). If YES, the EC 29 informs the BIOS of the power management event (EC event). This indicates that the BT module 28 and the wireless LAN module 27 are disabled, by generating an interruption signal to the CPU 21 or the like (step S109).

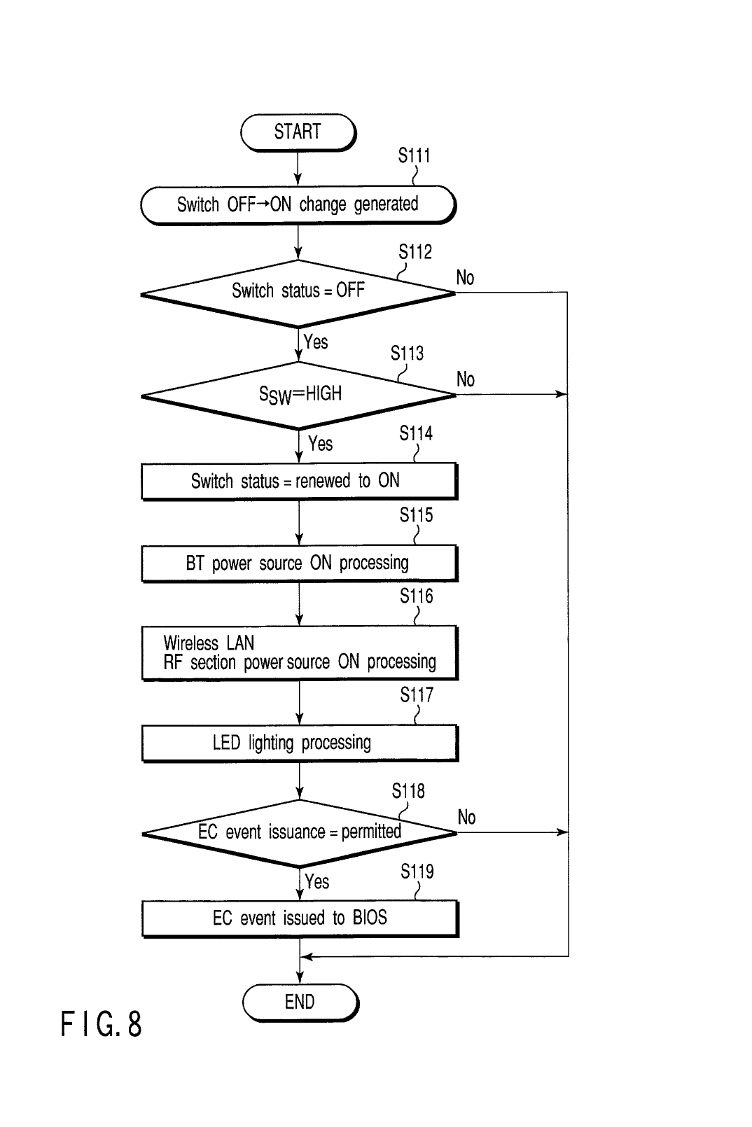

How the EC 29 operates when the wireless communication control switch 115 is turned on while the system remains on will be explained, with the flowchart of FIG. 8.

When the wireless communication control switch 115 is turned on (step S111), the EC 29 detects that the wireless communication control switch 115 has changed from OFF state to ON state, provided that the status management flag is OFF (indicating that the Wireless communication control switch 115 has been in OFF state) (YES in step S112), and the actual switch status signal S_{sw} is HIGH (YES in step S113). Next, the EC 29 changes the status of the status management flag from OFF to ON (step S114).

The EC 29 sets BT control signal SBT to “L” level, turning on the power source of the BT module 28 (step S115). At the same time, the EC 29 sets the wireless LAN control signal SWL to “L” level, turning on the power source of the RF transceiver 272 (step S116). Then, the EC 29 turns on the LED 116, informing the user that all wireless communication functions has been enabled (step S117). Thereafter, the EC 29 determines whether the issuance of power management event (EC event) to the BIOS is permitted or not (step S118). If YES, the EC 29 generates an interruption signal to the CPU 21 or the like (step S119), informing the BIOS of the power management event (EC event) and indicating that the BT module 28 and the wireless LAN module 27 have started the operation.

AS mentioned above, in the computer, besides the power switch 113 to power ON/OFF the system, the wireless communication control switch 115 is provided to enable or disable the BT module 28 and the wireless LAN module 27. Therefore, the user can annihilate the radiation of radio wave from the wireless communication devices 27 and 28 by a simple operation of the wireless communication control switch 115 and moreover securely, without turning off the system.

On the other hand, while the BT module 28 and the wireless LAN module 27 remain enabled, the computer can communicate by radio wave, with any external wireless communication device based on Bluetooth (TM) standard or any external wireless communication device based on IEEE802.11b standard.

As described above, it is most preferable to operate a single wireless communication control switch 115 to turn on and on the wireless communication devices 27 and 28. Alternatively, an operation switch may be provided for each wireless communication device. In this case, an LED indicating the operation state may be provided individually for each wireless communication device, too, or one LED that can emit light beams of different colors in various fashions, for example, continuously and intermittently, thereby to indicate various operating states of two or more wireless communication device.

In addition, the embodiment described is not sole embodiment of the present invention. Other embodiments can also be devised.

It should be noted that the power OFF state of the information-processing apparatus is not limited to the one described above. The power OFF state includes the operation OFF states such as sleep state, suspend state, and the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable information-processing apparatus powered on according to operation of a power switch, comprising:
a main body;
a first wireless communication device provided in the main body, configured to execute a wireless data communication according to a first communication protocol, by using radio wave;
a second wireless communication device provided in the main body, configured to execute a wireless data communication according to a second communication protocol, by using radio wave;
a wireless communication control switch provided on the main body; and
a controller provided in the main body, and connected to the wireless communication control switch, configured to disable the first and second wireless communication devices, when the wireless communication control switch is operated in a state where the portable information-processing apparatus is powered on.

2. The portable information-processing apparatus according to claim 1, wherein the controller comprises a control unit configured to shut off the supply of power to the first and second wireless communication devices.

3. The portable information-processing apparatus according to claim 2, wherein the first wireless communication device is connected to a bus in the portable information-processing apparatus, and includes a RF transceiver and a bus interface logic; and
the control unit includes a circuit configured to shut off the supply of the power to the RF transceiver, while maintaining the power supply to the bus interface logic in the first wireless communication device.

4. The portable information-processing apparatus according to claim 2, wherein the second wireless communication device is connected to a bus in the portable information-processing apparatus through an I/O controller; and
the control unit includes a circuit configured to shut off the power supply to all components in the second wireless communication device.

5. The portable information-processing apparatus according to claim 1, further comprising a status display device configured to display whether the fist and second wireless communication devices are in enable state or disable state.

6. The portable information-processing apparatus according to claim 1, wherein the controller comprises a control unit configured to shut off the supply of power to the first and second wireless communication devices, when the wireless communication control switch is changed over from ON state to OFF state in a state where the portable information-processing apparatus has been powered on, and configured to power on the first and second wireless communication devices, when the wireless communication control switch is changed over from OFF state to ON state in a state where the portable information-processing apparatus has been powered on.

7. A portable information-processing apparatus powered on according to operation of a power switch, comprising:
a main body;
a wireless communication device provided in the main body, configured to execute a wireless data communication by using radio wave of ISM band;
a wireless communication control switch provided on the main body; and
a controller provided in the main body, and connected to the wireless communication control switch, configured to disable the wireless communication devices, when the wireless communication control switch is operated in a state where the portable information-processing apparatus is powered on.

8. A portable information-processing apparatus comprising:
a bus;
a wireless communication device including a RF transceiver and a bus interface logic connected to the bus;
a power switch;
a power source control unit connected to the power switch, configured to supply power to all components in the portable information-processing apparatus to power on the apparatus, in accordance with an operation of the power switch;
a wireless communication control switch; and
a controller connected to the wireless communication control switch, configured to shut off the supply of the power to the RF transceiver, while maintaining the power supply to the bus interface logic, when the wireless communication control switch is operated in a state where the portable information-processing apparatus is powered on.

9. A method for controlling a first and second wireless communication devices provided in a portable information-processing apparatus, the method comprising:
detecting a operation of a wireless communication control switch provided in the portable information-processing apparatus; and
disabling the first and second wireless communication devices while maintaining the power supply to the components except for the first and second wireless communication devices, when the operation of the wireless communication control switch is detected.

10. The method according to claim 9, wherein the disabling includes shutting off the supply of the power to the first and second wireless communication devices.

11. The method according to claim 10, wherein the first wireless communication device is connected to a bus in the portable information-processing apparatus, and includes a RF transceiver and a bus interface logic; and
the shutting off includes shutting off the supply of the power to the RF transceiver, while maintaining the power supply to the bus interface logic in the first wireless communication device.

12. The method according to claim 10, wherein the second wireless communication device is connected to a bus in the portable information-processing apparatus through an I/O controller; and
the shutting off includes shutting off the power supply to all components in the second wireless communication device.

13. A method for controlling a portable information-processing apparatus including a bus, and a wireless communication device connected to the bus, including an RF transceiver and a bus interface logic, the method comprising:
detecting a operation of a wireless communication control switch provided in the portable information-processing apparatus; and
shutting off supplying a power to the RF transceiver, while maintaining the supply of the power to the bus interface logic, when the operation of the wireless communication control switch is detected.
